(19) United States
(12) Patent Application Publication
(10) Pub. No.: US 2015/0184730 A1
(43) Pub. Date: Jul. 2, 2015

(54) SINGLE AXIS ROBOT

(71) Applicants: HONG FU JIN PRECISION INDUSTRY (Shenzhen) CO., LTD., Shenzhen (CN); HON HAI PRECISION INDUSTRY CO., LTD., New Taipei (TW)

(72) Inventors: ZHEN-XING LIU, Shenzhen (CN); YUN ZHAO, Shenzhen (CN)

(21) Appl. No.: 14/569,971

(22) Filed: Dec. 15, 2014

(30) Foreign Application Priority Data
Dec. 30, 2013 (CN) 201310740719.4

(51) Int. Cl. F16H 25/24

(52) U.S. Cl. CPC F16H 25/2418; F16H 2025/2031

(57) ABSTRACT

A single axis robot includes a frame, a driving mechanism, a guiding mechanism, a hermetic band, and a protective cover. The driving mechanism is coupled to the frame. The guiding mechanism is coupled to the driving mechanism and includes a platform, a guiding member, and at least one elastic member. The platform is coupled to the driving mechanism. The guiding member is coupled to the platform. The hermetic band is positioned between the platform and the guiding member. Opposite ends of the hermetic band are coupled to the frame and configured to seal the frame. The protective cover covers the guiding member and is coupled to the platform. The at least one elastic member is positioned between the protective cover and the guiding member.

### FIELD

The subject matter herein generally relates to robots, and particularly to a single axis robot.

### BACKGROUND

Single axis robots can be used to drive a workpiece to achieve linear movement. To avoid dust, water, or oil from entering into the single axis robots, the single axis robots need to be designed in a sealed structure.

### BRIEF DESCRIPTION OF THE DRAWINGS

Implementations of the present technology will now be described, by way of example only, with reference to the attached figures.

FIG. 1 is an isometric view of an embodiment of a single axis robot including a guiding member.

FIG. 2 is an exploded, isometric view of the single axis robot of FIG. 1.

FIG. 3 is an enlarged, isometric view of the guiding member of the single axis robot of FIG. 2.

FIG. 4 is a cross-sectional view taken along line IV-IV of the single axis robot of FIG. 1.

FIG. 5 is a cross-sectional view taken along line V-V of the single axis robot of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is in relation to a single axis robot and can include a frame, a driving mechanism, a guiding mechanism, a hermetic band, and a protective cover. The driving mechanism can be coupled to the frame. The guiding mechanism can be coupled to the driving mechanism and can include a platform, a guiding member, and at least one elastic member. The platform can be coupled to the driving mechanism. The guiding member can be coupled to the platform. The hermetic band can be positioned between the platform and the guiding member. Opposite ends of the hermetic band can be coupled to the frame and configured to seal the frame. The protective cover can cover the guiding member and can be coupled to the platform. The at least one elastic member can be positioned between the protective cover and the guiding member.

The present disclosure is in relation to a single axis robot and can include a frame, a driving mechanism, a guiding mechanism, and a hermetic band. The driving mechanism can be coupled to the frame. The guiding mechanism can be coupled to the driving mechanism and can include a platform, a guiding member, and at least one elastic member. The platform can be coupled to the driving mechanism and include two first inclined surfaces. The guiding member can be coupled to the platform and include two second inclined surfaces corresponding to the first inclined surfaces. Each second inclined surface can resist one of the first inclined surfaces. The at least one elastic member can be positioned on the guiding member. The hermetic band can be positioned between the platform and the guiding member. Opposite ends of the hermetic band can be coupled to the frame.

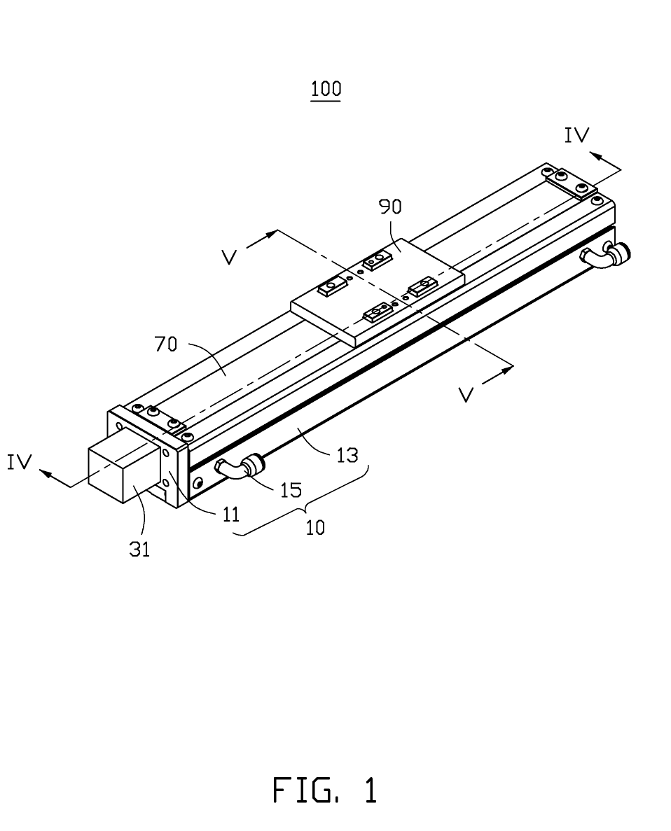

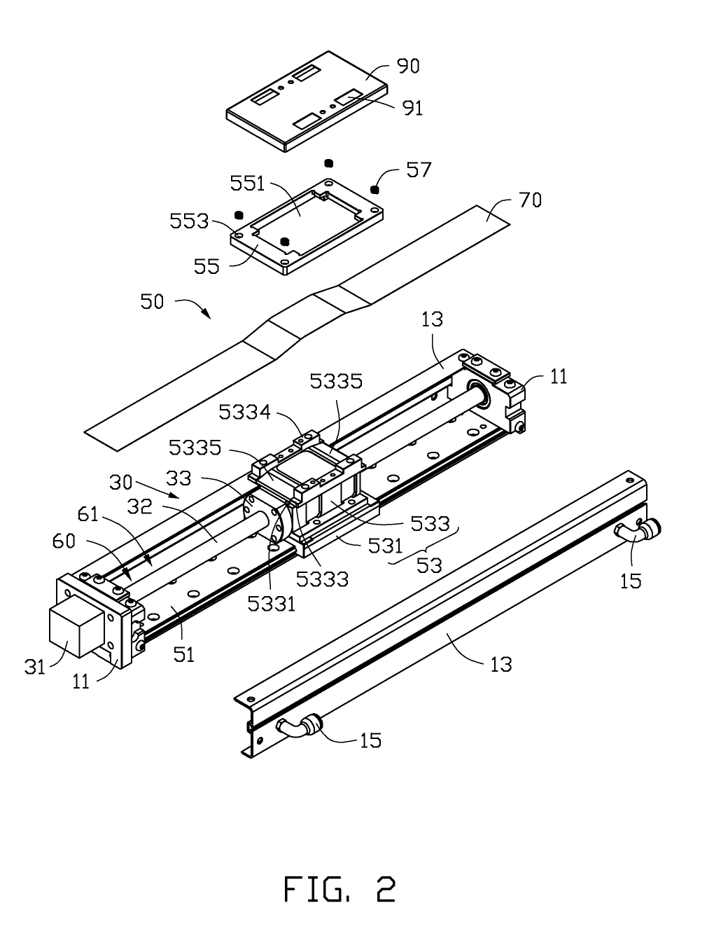

FIG. 1 illustrates an embodiment of a single axis robot 100. FIG. 2 illustrates that the single axis robot 100 can include a frame 10 (shown in FIG. 1), a driving mechanism 30, a guiding mechanism 50, a hermetic band 70, and a protective cover 90. The frame 10 can be configured to support and install the driving mechanism 30, the guiding mechanism 50, the hermetic band 70, and the protective cover 90. The driving mechanism 30 can be coupled to the frame 10 and partly received in the frame 10. The guiding mechanism 50 can be coupled to the driving mechanism 30. The driving mechanism 30 can move the guiding mechanism 50 linearly. The hermetic band 70 can be coupled to the frame 10 and configured to seal the frame 10. The protective cover 90 can cover and protect the guiding mechanism 50 to seal the guiding mechanism 50. In the illustrated embodiment, the single axis robot 100 is a linear robot.

The frame 10 can include two support bases 11, two sidewalls 13, and two joints 15. The support bases 11 can be oppositely arranged and substantially parallel to each other. The sidewalls 13 can be positioned between the support bases 11. Each sidewall 13 can be coupled to the support bases 11. The joints 15 can be coupled to one of the sidewalls 13. In the illustrated embodiment, each support base 11 can be substantially a cuboid. Each sidewall 13 can be substantially a U-shaped structure and the two sidewalls 13 can be positioned opposite to each other. The support bases 11 can be respectively positioned at opposite ends of the sidewalls 13. The joints 15 can be configured to couple with an outer air source. Thus, when the single axis robot 100 works in a dusty environment, air from the outer air source can be entered into the single axis robot 100 via the joints 15, to avoid dust from entering into the single axis robot 100. A working life of the single axis robot 100 thus can be extended. In at least one embodiment, a number of the joint 15 can be one or more than two. The joints 15 can be mounted on any position of the sidewalls 13.

The driving mechanism 30 can include a driver 31, a screw lead 32, and a movable member 33. The driver 31 can be coupled to one of the support bases 11 and positioned at outside of the frame 10. The screw lead 32 can be rotatably inserted through the support bases 11 and positioned between the support bases 11. An end portion of the screw lead 32 can protrude out from the frame 10 and coupled to the driver 31. The screw lead 32 can be substantially perpendicular to the support bases 11. The driver 31 can be configured to rotate the screw lead 32. The movable member 33 can be sleeved on the screw lead 32 and threaded with the screw lead 32. When the screw lead 32 rotates, the movable member 33 can slide along the screw lead 32.

The guiding mechanism 50 can include a guiding rail 51, a platform 53 coupled to the driving mechanism 30, a guiding member 55, and at least one elastic member 57. The guiding rail 51 can be substantially a rectangular plate. Opposite ends of the guiding rail 51 can be coupled to the support bases 11, respectively. Opposite side edges of the guiding rail 51 can be coupled to the sidewalls 13, respectively. The guiding rail 51 can be positioned between the sidewalls 13. The guiding rail 51, the sidewalls 13, and the support bases 11 can define a receiving chamber 60 having an opening 61, cooperatively. The screw lead 32 and the movable member 33 can be received in the receiving chamber 60. The guiding rail 51 can be parallel to the screw lead 32.

The platform 53 can be slidably coupled to the guiding rail 51 and sleeved on the screw lead 32. The platform 53 can be positioned at a side of the movable member 33 and fixed to the movable member 33. The platform 53 can be received in the receiving chamber 60. The platform 53 can include a sliding portion 531 and a main body 533 coupled to the sliding portion 531. The sliding portion 531 can be slidably coupled to the guiding rail 51. The main body 533 can be substantially a hollow cuboid and movably sleeved on the screw lead 32. The main body 533 can be coupled to the movable member 33. The main body 533 can move together with movable member 33 along the screw lead 32, thus the sliding portion 531 can slide along the guiding rail 51.

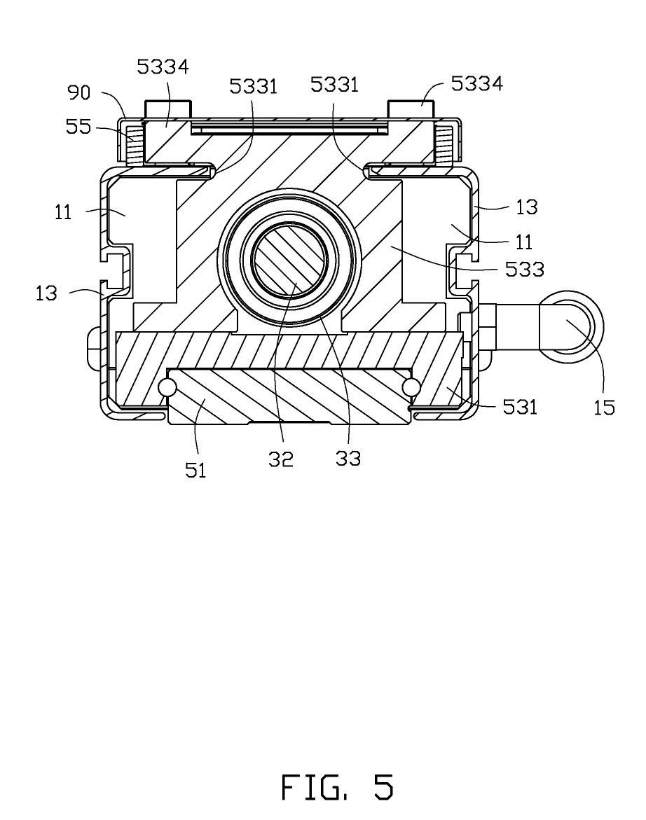

Two latching grooves 5331 (also shown in FIG. 5) can be defined at opposite sidewalls of the main body 533 and can be parallel to the screw lead 32. The sidewalls 13 can be latched to the latching grooves 5331, thus the main body 533 of the platform 53 can be latched with the sidewalls 13. A top surface of each sidewall 13 can resist the main body 533. Four first limiting portions 5333 can be depressed from four corners of a top of the main body 533. In the illustrated embodiment, each first limiting portion 5333 can be a groove. Four protruding portions 5334 can be formed at the top of the main body 533 and each protruding portion 5334 can be adjacent to one of the first limiting portions 5333. The protruding portions 5334 can be configured to couple a workpiece when in use. Two first inclined surfaces 5335 can be formed on the top of the main body 533 and can be symmetrically positioned at opposite ends of the main body 533.

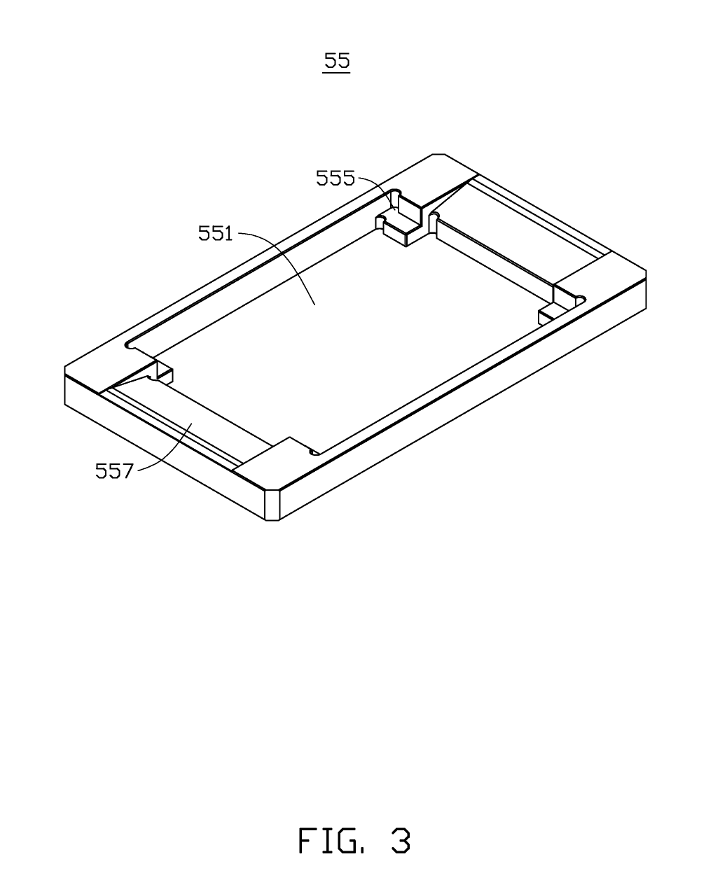

The guiding member 55 can be substantially in a shape of a closed frame and define a hollow portion 551 at substantially a center thereof. The guiding member 55 can be coupled to the platform 53. The guiding member 55 can define four receiving holes 553 at four corners thereof. FIG. 3 illustrates that the guiding member 55 can define four second limiting portions 555 corresponding to the first limiting portions 5333 and two second inclined surfaces 557 corresponding to the first inclined surfaces 5335. The second limiting portions 555 can be adjacent to four corners of the guiding member 55, respectively. Each second limiting portion 555 can be latched to one of the first limiting portions 5333. Each second inclined surface 557 can resist one of the first inclined surfaces 5335. The second limiting portions 555 and the second inclined surfaces 557 can be positioned at a side of the guiding member 55 adjacent to the platform 53.

In the illustrated embodiment, a number of the elastic member 57 can be four. The elastic members 57 can be positioned on the guiding member 55 and partly received in the receiving holes 553 of the guiding member 55, respectively. Each elastic member 57 can be exposed out from the guiding member 55 and configured to adjust a resisting force of the guiding member 55 to the sidewalls 13.

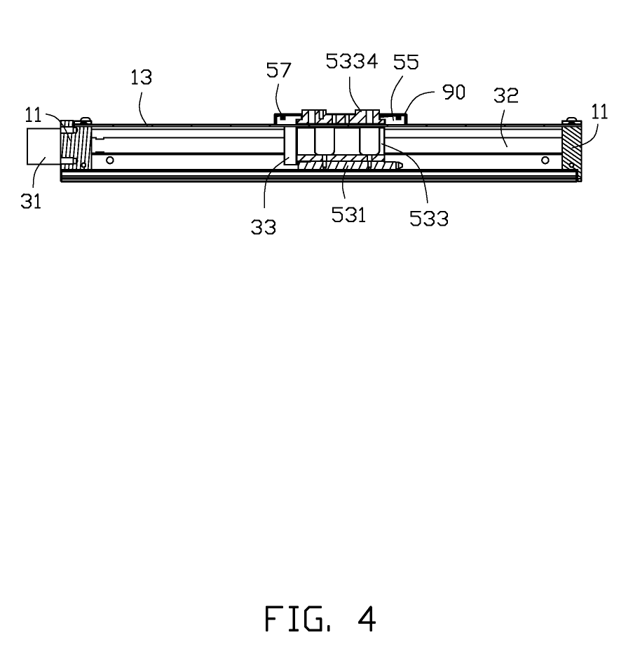

FIG. 4 illustrates that the guiding member 55 can be latched with the main body 533. FIG. 5 illustrates that the protruding portions 5334 can be exposed from the hollow portion 551. A bottom of the guiding member 55 can resist the sidewalls 13.

Referring to FIG. 2 again, two end portions of the hermetic band 70 can be respectively coupled to the support bases 11. The hermetic band 70 can be parallel to the screw lead 32. Two of the protruding portions 5334 can be positioned at a side of the hermetic band 70 and another two of the protruding portions 5334 can be positioned at an opposite side of the hermetic band 70. The hermetic band 70 can be positioned between the guiding member 55 and the main body 533 of the platform 53. The guiding member 55 can be positioned above the hermetic band 70. A top side of the hermetic band 70 can resist the second inclined surfaces 557 and a bottom side of the hermetic band 70 can resist the first inclined surfaces 5335 of the platform 53. The hermetic band 70 can be received in the opening 61 and two side edges of the hermetic band 70 can abut against the sidewalls 13, respectively, for sealing the receiving chamber 61. Thus, the hermetic band 70 can be configured to avoid dusts, oil, or water to enter into the receiving chamber 61. In the illustrated embodiment, the hermetic band 70 can be a steel band.

The protective cover 90 can cover the guiding member 55 and can couple to the main body 533. The elastic members 57 can resist the protective cover 90, thus the elastic members 57 can be positioned between the protective cover 90 and the guiding member 55. Opposite ends of each elastic member 57 can elastically resist the protective cover 90 and the guiding member 55, respectively. The protective cover 90 can define four through holes 91. The protruding portions 5334 can be inserted through the hollow portion 551 and the through holes 91, respectively. The elastic member 57 can elastically resist the guiding member 55 and the protective cover 90. A gap between the guiding member 55 and the sidewalls 13 can be adjusted via the elastic member 57.

In assembly, the support bases 11 can be positioned at opposite ends of the guiding rail 51 and parallel to each other. The movable member 33 can be sleeved on the screw lead 32. The platform 53 can be sleeved on the movable member 33. The driver 31 can be positioned on one of the support base 11. The hermetic band 70 can be arranged on the platform 53. The guiding member 55 can be mounted on the platform 53 can positioned above the hermetic band 70. The elastic members 57 can be mounted on the guiding member 55. The protective cover 90 can be mounted on the guiding member 55.

In use, a workpiece (not shown) can be positioned on the protruding portions 5334. The driver 31 can rotate the screw lead 32. The movable member 33 and the guiding member 55 can slide along the screw lead 32. Therefore, the workpiece can be moved linearly. When the workpiece moves, a force of friction between the guiding member 55 and the sidewalls 13 can be adjusted.

In at least embodiment, the movable member 33 can be omitted and the platform 53 can be threaded with the screw lead 32. The driving mechanism 30 can be other structures, such as a cylinder which directly drive the platform 53. A number of the elastic member 57 can be one or more than one.

The embodiments shown and described above are only examples. Many details are often found in the art such as the other features of a single axis robot. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A single axis robot comprising:
a frame;
a driving mechanism coupled to the frame;
a guiding mechanism coupled to the driving mechanism and comprising:
a platform coupled to the driving mechanism,
a guiding member coupled to the platform, and
at least one elastic member;
a hermetic band positioned between the platform and the guiding member, opposite ends of the hermetic band coupled to the frame and configured to seal the frame; and
a protective cover covering the guiding member and coupled to the platform,
wherein the at least one elastic member is positioned between the protective cover and the guiding member.

2. The single axis robot of claim 1, wherein the guiding member defines at least one receiving hole, the at least one elastic member is positioned on the guiding member and partly received in the at least one receiving hole of the guiding member.

3. The single axis robot of claim 1, wherein the frame comprises two support bases and two sidewalls, the support bases are oppositely arranged and substantially parallel to each other, the sidewalls are positioned between the support bases and coupled to the support bases, the opposite ends of the hermetic band are coupled to the support bases, respectively, two side edges of the hermetic band abut against the sidewalls.

4. The single axis robot of claim 3, wherein the driving mechanism comprises a driver, a screw lead, and a movable member, the driver is coupled to one of the support bases, the screw lead is rotatably inserted through the support bases and positioned between the support bases, an end portion of the screw lead protrudes out from the frame and coupled to the driver, the movable member is sleeved on the screw lead, the platform is coupled to the movable member.

5. The single axis robot of claim 4, wherein the guiding mechanism further comprises a guiding rail positioned between the sidewalls, opposite ends of the guiding rail are coupled to the support bases, respectively, the guiding rail, the sidewalls, and the support bases define a receiving chamber having an opening, cooperatively, the screw lead and the movable member are received in the receiving chamber, the hermetic band is received in the opening.

6. The single axis robot of claim 5, wherein the platform comprises a sliding portion and a main body coupled to the sliding portion, the sliding portion is slidably coupled to the guiding rail, the main body is movably sleeved on the screw lead and coupled to the movable member, the hermetic band is positioned between the guiding member and the main body.

7. The single axis robot of claim 6, wherein two latching grooves are defined at opposite sidewalls of the main body and parallel to the screw lead, the sidewalls are latched to the latching grooves.

8. The single axis robot of claim 6, wherein four first limiting portions are depressed from four corners of a top of the main body, the guiding member defines four second limiting portions corresponding to the first limiting portions, each second limiting portion is latched to one of the first limiting portions.

9. The single axis robot of claim 8, wherein the guiding member defines a hollow portion at substantially a center thereof, at least one protruding portion is formed at the top of the main body, the protective cover defines at least one through hole, the at least one protruding portion is inserted through the hollow portion and the at least one through hole.

10. The single axis robot of claim 6, wherein two first inclined surfaces are formed on the top of the main body and symmetrically positioned at opposite ends of the main body, the guiding member comprises two second inclined surfaces corresponding to the first inclined surfaces, each second inclined surface resists one of the first inclined surfaces, a top side of the hermetic band resists the second inclined surfaces and a bottom side of the hermetic band resists the first inclined surfaces.

11. A single axis robot comprising:
a frame;
a driving mechanism coupled to the frame;
a guiding mechanism coupled to the driving mechanism and comprising:
a platform coupled to the driving mechanism and comprising two first inclined surfaces,
a guiding member coupled to the platform and comprising two second inclined surfaces corresponding to the first inclined surfaces, each second inclined surface resisting one of the first inclined surfaces, and
at least one elastic member positioned on the guiding member; and
a hermetic band positioned between the platform and the guiding member, opposite ends of the hermetic band coupled to the frame.

12. The single axis robot of claim 11, wherein the guiding member defines at least one receiving hole, the at least one elastic member is positioned on the guiding member and partly received in the at least one receiving hole of the guiding member.

13. The single axis robot of claim 12 further comprising:
a protective cover covering the guiding member and coupled to the platform, the at least one elastic member positioned between the protective cover and the guiding member.

14. The single axis robot of claim 11, wherein the frame comprises two support bases and two sidewalls, the support bases are oppositely arranged and substantially parallel to each other, the sidewalls are positioned between the support bases and coupled to the support bases, the opposite ends of the hermetic band are coupled to the support bases, respectively, two side edges of the hermetic band abut against the sidewalls.

15. The single axis robot of claim 14, wherein the driving mechanism comprises a driver, a screw lead, and a movable member, the driver is coupled to one of the support bases, the screw lead is rotatably inserted through the support bases and positioned between the support bases, an end portion of the screw lead protrudes out from the frame and coupled to the driver, the movable member is sleeved on the screw lead, the platform is coupled to the movable member.

16. The single axis robot of claim 15, wherein the guiding mechanism further comprises a guiding rail positioned between the sidewalls, opposite ends of the guiding rail are coupled to the support bases, respectively, the guiding rail, the sidewalls, and the support bases define a receiving chamber having an opening, cooperatively, the screw lead and the movable member are received in the receiving chamber, the hermetic band is received in the opening.

17. The single axis robot of claim 16, wherein the platform comprises a sliding portion and a main body coupled to the sliding portion, the sliding portion is slidably coupled to the guiding rail, the main body is movably sleeved on the screw lead and coupled to the movable member, the hermetic band is positioned between the guiding member and the main body.

18. The single axis robot of claim 17, wherein two latching grooves are defined at opposite sidewalls of the main body and parallel to the screw lead, the sidewalls are latched to the latching grooves.

19. The single axis robot of claim 17, wherein four first limiting portions are depressed from four corners of a top of the main body, the guiding member defines four second limiting portions corresponding to the first limiting portions, each second limiting portion is latched to one of the first limiting portions.

20. The single axis robot of claim 19, wherein at least one joint is coupled to one of the sidewalls.
